(19) United States
(12) Patent Application Publication
(10) Pub. No.: US 2026/0280215 A1
(43) Pub. Date: Sep. 17, 2026

(54) B-INTEGRAL COMPENSATION IN CHIRPED PULSE AMPLIFICATION

(71) Applicant: Coherent Scotland Limited, Glasgow (GB)

(72) Inventors: Daniel MORRIS, Falkirk (GB); Martin ENGELBRECHT, East Dunbartonshire (GB); Irina TRIFANOV, East Dunbartonshire (GB)

(73) Assignee: Coherent Scotland Limited, Glasgow (GB)

(21) Appl. No.: 19/168,755

(22) PCT Filed: Mar. 26, 2024
(86) PCT No.: PCT/GB2024/050812

§ 371 Date: Sep. 24, 2025

(30) Foreign Application Priority Data
Mar. 31, 2023 (GB) 2304869.7

(51) Int. Cl. H01S 3/00

(52) U.S. Cl. CPC H01S 3/0057

(57) ABSTRACT

A method for chirped pulse amplification stretches laser pulses from an ultrashort duration to a longer duration, sets a repetition rate of the laser pulses delivered to one or more nonlinear laser amplifiers, amplifies the laser pulses in the nonlinear amplifier(s), and then recompresses the stretched, amplified laser pulses. The magnitude of a B-integral imposed by each nonlinear amplifier increases with pump power and decreases with pulse repetition rate. The final duration and/or spectral characteristic(s) of the recompressed laser pulses are sensitive to a total B-integral imposed by the nonlinear amplifier(s). The method also changes the repetition rate from a first to a second repetition rate, and, in conjunction herewith, adjusts the pump power for at least one nonlinear amplifier to achieve approximately the same final duration and/or spectral characteristic(s) at the first and second repetition rates without changing the chromatic dispersion imposed by the compressor.

### CROSS-REFERENCE TO RELATED APPLICATIONS

This application is a U.S. national stage application under 35 U.S.C. § 371 of International Application No. PCT/GB2024/050812, filed Mar. 26, 2024, which claims the priority of GB Patent Application No. 2304869.7, filed Mar. 31, 2023. The entire contents of each priority application is incorporated herein by reference.

### FIELD OF THE DISCLOSURE

The present invention relates to achieving a desired pulse duration of amplified ultrashort laser pulses over a range of pulse repetition rates. The present invention relates in particular to the management of power-dependent phase shifts in laser amplifiers used to amplify the laser pulses in a chirped pulse amplification (CPA) system.

### BACKGROUND OF THE DISCLOSURE

Generation of high-power laser radiation is often accomplished using the master-oscillator power-amplifier (MOPA) architecture. The master oscillator is a laser that generates laser radiation of relatively low power. This low-power laser radiation is subsequently amplified in a laser amplifier or a chain of laser amplifiers. Each such laser amplifier is optimized to handle and generate higher laser powers than the preceding stage. The MOPA architecture may be applied to both continuous-wave and pulsed laser radiation. Direct amplification of ultrashort pulses is, however, often not feasible. Ultrashort laser pulses have durations of up to a few tens of picoseconds (ps). The peak powers are correspondingly high, especially if amplified. Even if a laser amplifier is designed to withstand the high peak powers of ultrashort laser pulses, nonlinear effects are likely to cause an unacceptable degree of pulse distortion due to, e.g., self-phase modulation.

Chirped pulse amplification circumvents these issues associated with amplification of ultrashort laser pulses by lengthening the duration of the laser pulses prior to amplification such that amplification is applied to laser pulses with reduced peak powers. The initially ultrashort pulse duration may be stretched to as much as nanoseconds. After amplification, the laser pulses are recompressed into the ultrashort regime. The spectral bandwidth of ultrashort laser pulses is utilized to lengthen and shorten their duration. The stretcher of a CPA system chirps each laser pulse by imposing an optical path length that either increases or decreases with the wavelength of the laser radiation. This chromatic dispersion stretches the pulse. After amplification, the initial ultrashort pulse duration is at least partly or approximately restored in a compressor that imposes the opposite chromatic dispersion from the stretcher. Either one of stretching and compression may be performed by, e.g., free-space diffraction gratings, prisms, chirped Bragg gratings (implemented in a bulk optic or an optical fiber), or dispersive optical fibers. Free-space diffraction gratings and prisms are the most common choices for the compression because the positions of the optical elements in a free-space-grating-or prism-based design can be adjusted to most-accurately cancel out the dispersion of the stretched laser pulses.

Compressor adjustability is particularly useful in CPA systems with variable pulse repetition rates and varying pulse energies as a result thereof. The repetition rate is typically set by a pulse picker, such as an acousto-optic modulator. The pulse picker forwards only a subset of the initial laser pulse train, for example every 10^{th} or 20^{th} laser pulse, and discards the rest of the laser pulses. In order to limit the power-handling requirements and maximize power-extraction of the pulse picker, the pulse picker is typically positioned where the pulse energy is relatively low. Subsequent amplification may, however, be affected by the pulse repetition rate, especially in high-power scenarios where the gain in a laser amplifier is limited by the available pump power. In such scenarios, less gain per pulse is available at higher pulse repetition rates, resulting in the energy of the amplified laser pulses depending on the pulse repetition rate. As a further consequence of the per-pulse-gain and pulse energy depending on pulse repetition rate, any nonlinear phase shifts in the gain medium/media will render the spectrotemporal distribution of each amplified laser pulse sensitive to the pulse repetition rate.

Herein, unless specifically stated otherwise, “nonlinear” phase shifts are phase shifts that depend on the light intensity (and may or may not depend on wavelength). Nonlinear phase shifts are caused by the Kerr effect and can, at least to a good approximation, be described as a nonlinear change in the refractive index Δn=n₂I, wherein n₂ is the nonlinear refractive index and I is the light intensity.

When an ultrafast laser pulse passes through a medium with a non-negligible nonlinear refractive index (i.e., a “nonlinear” medium), leading and trailing edges of the laser pulse will experience lesser nonlinear phase shifts than the more intense temporal center of the laser pulse. The nonlinear medium therefore modulates the temporal phase and, thus, the instantaneous frequency within the laser pulse. As a result, the spectral distribution within the laser pulse depends on the pulse energy. Any linear dispersion of the medium further compounds this effect. As the laser pulse propagates through the nonlinear medium, linear dispersion of the medium in combination with the nonlinear phase shifts may cause the pulse duration to change. This change in pulse duration also depends on the pulse energy.

The nonlinear phase shift experienced by laser radiation passing through an optical element is often quantified by the B-integral, B=2π/λ∫n₂I(z)dz, where z is distance along the propagation path of the laser radiation. The B-integral is the nonlinear phase shift accumulated, on the optical axis (z-axis), in passage through the optical element. For a laser pulse, the B-integral is usually calculated as B=2π/λ~n₂Iₚₑₐₖ(z)dz, wherein Iₚₑₐₖ is the peak intensity. Herein, a “nonlinear” laser amplifier is an amplifier that has a non-negligible nonlinear phase shift such that laser pulses passing through the gain medium of the nonlinear laser amplifier accumulate a non-negligible B-integral. Although the B-integral does not necessarily provide a complete characterization of the nonlinear phase shift and related effects, the B-integral is one quantitative measure thereof.

When the pulse picker of a conventional CPA system, or other ultrashort-pulse MOPA system, is followed by one or more nonlinear laser amplifiers with pump-power-limited gain, the amplified pulse energy decreases with pulse repetition rate. The B-integral therefore also decreases with the pulse repetition rate. As a result, the spectrotemporal distribution of the amplified laser pulses depends on the pulse repetition rate. In other words, the exact nature of the chirp, and often also the pulse duration, depends on the pulse repetition rate. In a conventional CPA system, unless changes in pulse repetition rate are accompanied by changes to the compressor, the compressor will produce different output pulse characteristics at different pulse repetition rates. With free-space-grating-and prism-based compressors, it is possible to adjust the chromatic dispersion imposed by the compressor to achieve at least approximately the same pulse characteristics at different pulse repetition rates. For this purpose, some CPA systems with a free-space-grating- or prism-based compressor include one or more manual or motorized stages that reposition optical elements of the compressor when the pulse repetition rate is changed.

### SUMMARY OF THE DISCLOSURE

Disclosed herein are systems and methods for B-integral compensation in CPA systems with variable pulse repetition rate and pump-power-limited nonlinear amplification. The present B-integral compensation technique enables achieving consistent output pulse durations and/or spectral characteristics over a wide range of pulse repetition rates. In contrast to conventional methods relying on repositioning of optical elements of the compressor when the pulse repetition rate changes, the present B-integral compensation technique does not require repositioning of optical elements. Instead, B-integral compensation is implemented directly in the nonlinear amplification process in the form of pump-power adjustments. The present B-integral compensation technique therefore eliminates both the alignment challenges of conventional compressor adjustment and the associated hardware cost. Additionally, whereas the dispersion corrections made in conventional compressor adjustment methods are limited to linear and quadratic terms (as a function of optical frequency), the present B-integral compensation technique is not limited to terms of particular orders. The present B-integral compensation technique is applicable to CPA systems with one or more nonlinear laser amplifiers. In systems with a chain of nonlinear laser amplifiers, B-integral compensation may be effected by adjusting the pump power in several of these nonlinear laser amplifiers. However, in many cases, it is sufficient to adjust the pump power of a single nonlinear laser amplifier within the amplifier chain.

The applicability of the present B-integral compensation technique extends beyond CPA systems. More generally, the present B-integral compensation technique may be used to achieve a desired pulse duration and/or spectral characteristic over a range of pulse repetition rates in ultrashort laser systems with nonlinear amplification.

In one aspect of the invention, a method for chirped pulse amplification includes steps of stretching laser pulses from an initial ultrashort duration to a longer duration, setting a pulse repetition rate of the laser pulses delivered to one or more nonlinear laser amplifiers, and amplifying the laser pulses in the one or more nonlinear laser amplifiers. An absolute value of a B-integral imposed on the laser pulses by each nonlinear laser amplifier is an increasing function of a respective pump power and a decreasing function of the pulse repetition rate. The method further includes, after the stretching and amplifying steps, a step of compressing the laser pulses to a final ultrashort duration by imposing a chromatic dispersion on the laser pulses. A final spectrotemporal characteristic of the laser pulses, after the compressing step, is sensitive to a total B-integral imposed by the one or more nonlinear laser amplifiers. Additionally, the method includes (a) changing the pulse repetition rate from a first pulse repetition rate to a second pulse repetition rate, and (b) for at least one of the one or more nonlinear laser amplifiers, adjusting the respective pump power from a first pump power at the first pulse repetition rate to a second pump power at the second pulse repetition rate. The first and second pump powers, for each nonlinear laser amplifier adjusted, are selected to maintain the final spectrotemporal characteristic at the first and second pulse repetition rates while the chromatic dispersion imposed in the compressing step is the same at the first and second pulse repetition rates. The second pulse repetition rate and the second pump power exceed the first pulse repetition rate and the first pump power, respectively, or the first pulse repetition rate and the first pump power exceed the second pulse repetition rate and the second pump power, respectively.

In another aspect of the invention, a method for generating amplified ultrashort laser pulses includes steps of generating laser pulses with an initial optical frequency, an initial spectral lobe, and an initial ultrashort pulse duration, setting a pulse repetition rate of the laser pulses delivered to one or more nonlinear laser amplifiers having a first maximum-gain frequency offset from the initial optical frequency, and nonlinearly amplifying the laser pulses in the one or more nonlinear laser amplifiers to generate, through self-phase modulation, a new spectral lobe. The new spectral lobe is offset from the initial spectral lobe and contains the first maximum-gain frequency. An absolute value of a B-integral imposed on the laser pulses by each nonlinear laser amplifier is an increasing function of a respective pump power and a decreasing function of the pulse repetition rate. The method further includes, after the step of nonlinearly amplifying the laser pulses, a step of linearly amplifying the laser pulses in a linear laser amplifier having a second maximum-gain frequency contained by the new spectral lobe, whereby the linearly amplifying step preferentially amplifies the new spectral lobe resulting in a final ultrashort duration of the laser pulses after the linearly amplifying step. A final spectrotemporal characteristic of the laser pulses, after the linearly amplifying step, is sensitive to a total B-integral imposed by the one or more nonlinear laser amplifiers. Additionally, the method includes (a) changing the pulse repetition rate from a first pulse repetition rate to a second pulse repetition rate, and (b) for at least one of the one or more nonlinear laser amplifiers, adjusting the respective pump power from a first pump power at the first pulse repetition rate to a second pump power at the second pulse repetition rate. The first and second pump powers, for each nonlinear laser amplifier subject to said adjusting, are selected to maintain the final spectrotemporal characteristic at the first and second pulse repetition rates. The second pulse repetition rate and the second pump power exceed the first pulse repetition rate and the first pump power, respectively, or the first pulse repetition rate and the first pump power exceed the second pulse repetition rate and the second pump power, respectively.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates an ultrashort-pulsed laser apparatus with chirped pulse amplification and a variable pulse repetition rate, according to an embodiment. The CPA portion of the apparatus includes one or more pump-power-limited nonlinear laser amplifiers. The apparatus implements B-integral compensation in the nonlinear amplification process.

FIG. 2 schematically illustrates the B-integral accumulated by a laser pulse during propagation through a nonlinear laser amplifier in an example of the FIG. 1 apparatus, and the sensitivity of the B-integral to pulse repetition rate in the absence of B-integral compensation.

FIG. 3 illustrates a compressor of one example of the FIG. 1 apparatus.

FIG. 4 is a flowchart for a method for chirped pulse amplification with B-integral compensation implemented by the FIG. 1 apparatus, according to an embodiment.

FIG. 5 schematically illustrates the B-integral accumulated by a laser pulse in a nonlinear amplification module in an embodiment of the FIG. 1 apparatus where the nonlinear amplification module contains only a single nonlinear laser amplifier. FIG. 5 plots the accumulated B-integral at the two different pulse repetition rates in the FIG. 4 method, with B-integral compensation.

FIG. 6 illustrates an example of B-integral overcompensation in a last nonlinear laser amplifier of a chain of nonlinear laser amplifiers to compensate not only for the effect of pulse repetition rate on the B-integral accumulation in the last nonlinear laser amplifier but also for changes to the B-integral accumulated in other preceding nonlinear laser amplifiers that are not adjusted when the pulse repetition rate is modified.

FIG. 7 is a data plot showing exemplary final ultrashort pulse durations obtained by an embodiment of the FIG. 1 apparatus at three different pulse repetition rates, with B-integral compensation according to method 400 (open circles) and, for comparison, without B-integral compensation (solid circles). B-integral compensation was implemented according to the single-amplifier-overcompensation scheme of FIG. 6.

FIG. 8 illustrates an example of another single-amplifier-overcompensation scheme, wherein the adjusted nonlinear laser amplifier is not the last nonlinear laser amplifier of the chain.

FIG. 9 illustrates an ultrashort-pulse MOPA laser apparatus with a variable pulse repetition rate, according to an embodiment. The apparatus implements B-integral compensation in a nonlinear amplification process.

FIG. 10 illustrates spectral laser pulse evolution in an embodiment of the FIG. 9 apparatus, wherein self-phase modulation in the nonlinear amplification module serves to spectrally broaden the laser pulses before linear amplification.

FIG. 11 illustrates spectral laser pulse evolution in another embodiment of the FIG. 9 apparatus, wherein self-phase modulation in the nonlinear amplification module serves to generate a new spectral lobe that is at least nearly transform limited.

### DETAILED DESCRIPTION OF THE DISCLOSURE

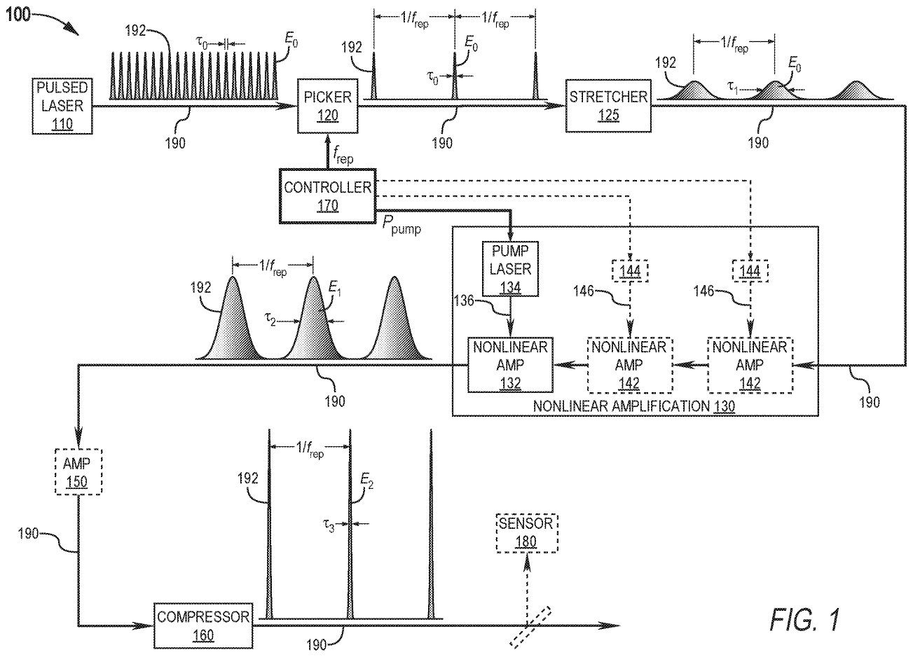

Referring now to the drawings, wherein like components are designated by like numerals, FIG. 1 illustrates one ultrashort-pulsed laser apparatus 100 with chirped pulse amplification and a variable pulse repetition rate. The CPA portion of apparatus 100 includes one or more pump-power-limited nonlinear laser amplifiers with pump-power-limited gain. Apparatus 100 implements B-integral compensation in the nonlinear amplification process such that consistent laser pulse durations may be achieved over a range of pulse repetition rates.

Apparatus 100 includes a pulsed laser 110, a pulse picker 120, and a CPA system with a stretcher 125, a nonlinear amplification module 130, and a compressor 160. Laser 110 generates a laser beam 190 of laser pulses 192 with an initial ultrashort pulse duration to. Pulse picker 120 sets a pulse repetition rate fᵣₑₚ of laser beam 190 by forwarding only a subset of laser pulses 192 generated by laser 110, and discarding the rest. In one example, laser 110 generates laser pulses 192 at an initial pulse repetition rate that is tens or hundreds of megahertz (MHz), and pulse picker 120 reduces this initial pulse repetition rate by about a factor of ten, or more, to a pulse repetition rate that is tens of MHz or less. Stretcher 125 stretches laser pulses 192 to a longer pulse duration τ₁ that is typically not ultrashort. For example, pulse duration τ₁ may be in the nanosecond range. Stretcher 125 may include one or more prims, gratings, grisms, free-space Bragg gratings, fiber Bragg gratings, or dispersive optical fibers to stretch laser pulses 192. While FIG. 1 shows pulse picker 120 as preceding stretcher 125, pulse picker 120 may instead be positioned after or integrated with stretcher 125.

Nonlinear amplification module 130 is positioned after pulse picker 120 and amplifies laser pulses 192 from an initial pulse energy E₀ to a larger pulse energy E₁. Although not shown in FIG. 1, losses between laser 110 and nonlinear amplification module 130 may cause reductions in the pulse energy generated by laser 110. Similarly, optional linear preamplifiers, not depicted, may increase the pulse energy between laser 110 and nonlinear amplification module 130. Such losses and gains are inconsequential to the present B-integral compensation technique and are ignored herein.

Nonlinear amplification module 130 includes a nonlinear laser amplifier 132 and a pump laser 134. Pump laser 134 generates a pump beam 136 that energizes the gain medium of nonlinear laser amplifier 132. Nonlinear amplification module 130 may also include one or more additional nonlinear laser amplifiers 142, each pumped by a respective pump beam 146 generated by a respective pump laser 144. (Although not shown in FIG. 1, the respective pump beams for two or more nonlinear laser amplifiers of nonlinear amplification module 130 may be generated by a single pump laser.) In the example depicted in FIG. 1, nonlinear laser amplifier 132 is the last nonlinear laser amplifier in a chain of three. In another example, nonlinear amplification module 130 includes at least one nonlinear laser amplifier 142 after nonlinear laser amplifier 132. In one embodiment, nonlinear laser amplifier 132 and optional nonlinear laser amplifier(s) 142, if included, are fiber amplifiers.

In the embodiment depicted in FIG. 1, nonlinear amplification module 130 is positioned after stretcher 125. In an alternative embodiment, a portion of nonlinear amplification module 130, for example one or more nonlinear laser amplifiers 142, is positioned before and/or integrated with stretcher 125.

Apparatus 100 may also include one or more nonlinear laser amplifiers before pulse picker 120. Such nonlinear laser amplifiers are, however, not affected by changes in pulse repetition rate because such nonlinear laser amplifiers experience a constant pulse repetition rate. Such nonlinear laser amplifiers are therefore ignored herein.

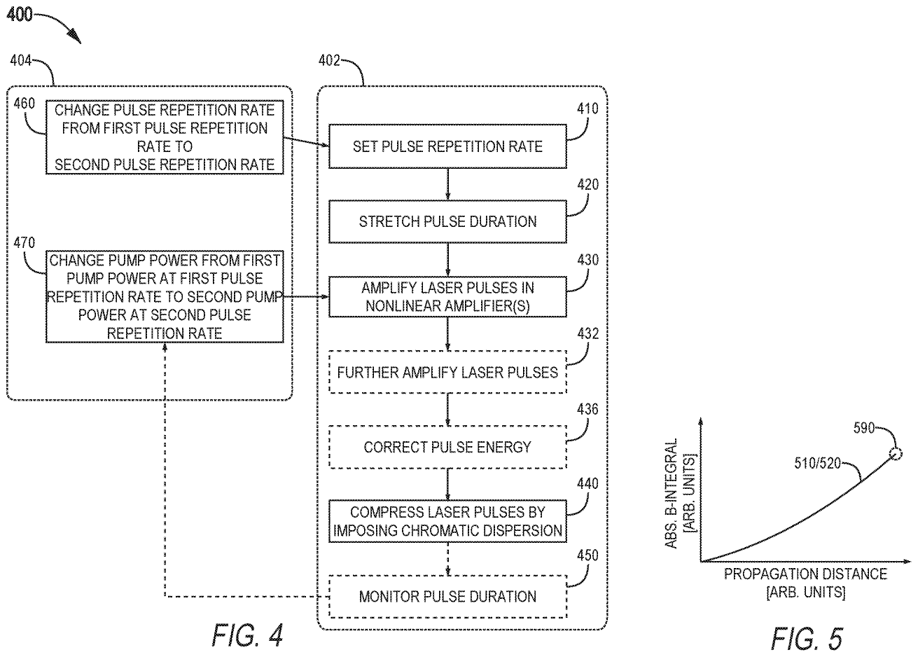

Apparatus 100 further includes a controller 170 communicatively coupled with pulse picker 120 and nonlinear amplification module 130. Controller 170 may be a computer, a field-programmable gate array, other electronic circuitry, or a combination thereof. Controller 170 regulates the pulse repetition rate set by pulse picker 120. Controller 170 also sets the power Pₚᵤₘₚ of pump beam 136. Optionally, controller 170 further sets the power(s) of one or more pump beams 146 energizing one or more respective additional nonlinear laser amplifiers 142. As will be discussed in further detail below in reference to FIG. 4, controller 170 is responsible for B-integral compensation in apparatus 100.

After nonlinear amplification module 130, laser pulses 192 have a pulse duration τ₂ that may be similar to but not necessarily the same as pulse duration τ₁. Compressor 160 compresses laser pulses 192 to a final ultrashort duration τ₃. Final ultrashort duration τ₃ may or may not be the same as initial pulse duration τₒ. Compressor 160 includes one or more dispersive optical elements, such as one or more prims, gratings, and/or grisms, that impose a chromatic dispersion on laser pulses 192 to compress their duration. The chromatic dispersion imposed by compressor 160 can be characterized by measuring the time delay, imposed by compressor 160, between two different spectral components of laser pulse 192. Specifically, two wavelengths of light are injected simultaneously into the compressor, and the accumulated time delay between those two wavelengths when they emerge from the compressor is measured. The two wavelengths may be a shorter wavelength within a laser pulse and a longer wavelength within the same laser pulse.

The non-negligible nonlinear phase shift in nonlinear amplification module 130 changes the spectral distribution within each laser pulse 192. Any optical elements with non-negligible linear dispersion, in nonlinear amplification module 130 and between nonlinear amplification module 130 and compressor 160 may modify the pulse duration of laser pulse 192. This pulse duration modification depends on the spectral distribution within laser pulse 192 and therefore on the nonlinear phase shift in nonlinear amplification module 130. Thus, stated more broadly, nonlinear amplification module 130 induces changes in the spectrotemporal profile of each laser pulse 192. The effect may be quantified by the B-integral accumulated by each laser pulse 192 when propagating through the gain medium (media) of nonlinear amplification module 130.

The gain in nonlinear laser amplifier 132 is limited by the power Pₚᵤₘₚ of pump beam 136. Similarly, the gain in each nonlinear laser amplifier 142 included (if any) is limited by the power of the corresponding pump beam 146. Consider a scenario without the present B-integral compensation technique where the pump power(s) in nonlinear amplification module 130 are fixed. In this uncompensated scenario, changes in the pulse repetition rate affect the gain available for each individual laser pulse 192 and thus change the energy of laser pulses 192 while propagating through the nonlinear gain medium (media) of nonlinear amplification module 130. As a result, in the case of constant pump power(s), the B-integral accumulated by each laser pulse 192 in propagation through nonlinear amplification module 130 varies with the pulse repetition rate.

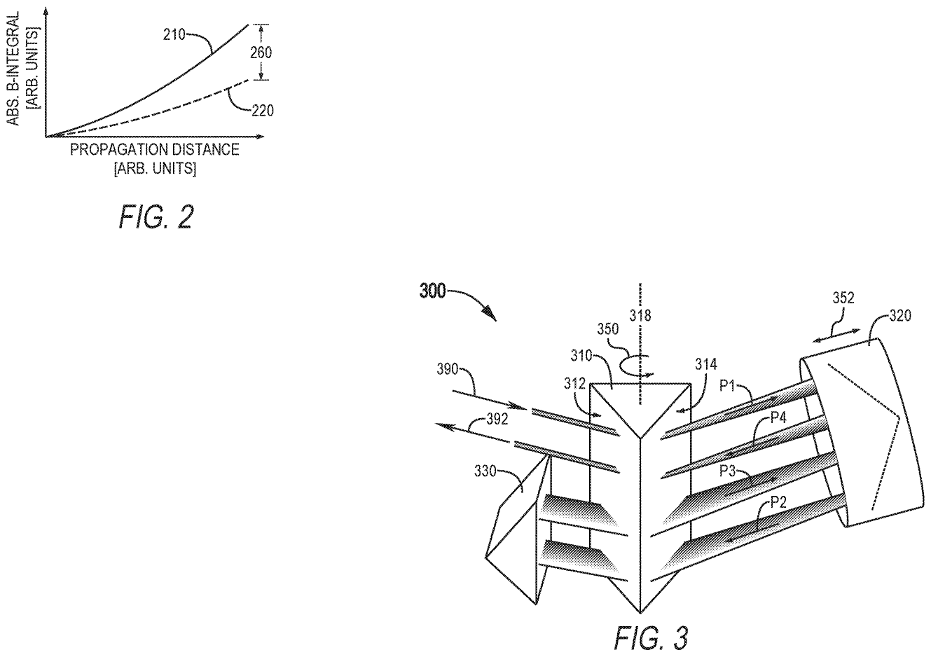

FIG. 2 schematically illustrates the B-integral accumulated by laser pulse 192 during propagation through a nonlinear laser gain medium of nonlinear amplification module 130, and the sensitivity of the B-integral to pulse repetition rate in the absence of B-integral compensation in nonlinear amplification module 130. FIG. 2 plots the absolute B-integral accumulated by laser pulse 192, as a function of propagation distance through the gain medium of nonlinear laser amplifier 132, for two different pulse repetition rates and a fixed power of pump beam 136. (A B-integral can be negative or positive. Glass has a positive nonlinear refractive index n₂ for typical laser wavelengths, but certain other materials, for example some organic liquids, have a negative nonlinear refractive index n₂.) Curves 210 and 220 pertain to lower and higher pulse repetition rates, respectively.

If the pump power is kept the same at both pulse repetition rates, less gain per pulse is available at the higher pulse repetition rate (curve 220) than at the lower pulse repetition rate (curve 210). Therefore, the B-integral grows more slowly as a function of propagation distance at the higher pulse repetition rate than at the lower pulse repetition rate. (The exact shapes of the curves may differ from those shown in FIG. 2). After the full propagation length, the two accumulated B-integrals differ by an amount 260. In one example, the higher pulse repetition rate (curve 220) is twice the lower pulse repetition rate (curve 210), and the accumulated B-integral at the higher pulse repetition rate is approximately half the accumulated B-integral at the lower pulse repetition rate. In this example, difference 260 represents a significant difference in the spectrotemporal profile of laser pulses 192 between the two different pulse repetition rates. In the absence of mitigation, compressor 160 will not compress laser pulses 192 to the same final ultrashort pulse duration τ₃ at both pulse repetition rates.

Conventional CPA systems adjust the compressor to compensate for the different spectrotemporal profiles of amplified laser pulses delivered to the compressor at different respective pulse repetition rates. This is however a difficult task that adds considerable hardware and alignment effort.

FIG. 3 illustrates a compressor 300 that is one exemplary embodiment of compressor 160. U.S. Pat. No. 7,474,467 describes such a compressor in more detail. Compressor 300 includes a prism 310, a corner cube 320, and a retroreflector 330. Prism 310 has two surfaces 312 and 314. Compressor 300 receives laser pulses 192 propagating along a propagation direction 390 toward surface 312. Compressed laser pulses 192 emerge from compressor 300 at surface 312 and propagate away from surface 312 along a propagation direction 392. Corner cube 320 and retroreflector 330 are arranged such that laser pulses 192 make four passes, P1, P2, P3, and P4, through prism 310. In each pass, surfaces 312 and 314 refract laser pulses 192. The chromatic dispersion imposed by these four passes through prism 310 depends on (a) the orientation of prism 310 about a longitudinal axis 318 and (b) the distance between prism 310 and corner cube 320. Any given spectral distribution is optimally compressed by a particular combination of prism orientation and prism-to-corner-cube distance.

In a conventional approach utilizing compressor adjustments to compensate for the different spectral distributions resulting from different pulse repetition rates, the prism orientation is adjusted as indicated by arrow 350, and corner cube 320 is moved closer to or away from prism 310 as indicated by arrow 352. These adjustments require two motorized stages and a calibration procedure for each anticipated pulse repetition rate. Compressor 300 represents one of the simplest adjustable compressors in terms of the number of optical elements. Many compressors include two or four dispersive optical elements, thereby further complicating the task of adjusting the compressor to compensate for different spectrotemporal profiles of the incident laser pulses.

Referring again to FIG. 1, apparatus 100 avoids the complexities of compressor adjustments. Apparatus 100 instead implements B-integral compensation directly in nonlinear amplification module 130 where the issues arise in the first place. More specifically, apparatus 100 changes one or more pump powers to compensate for the changes in pulse repetition rate. In a simple scenario where nonlinear laser amplifier 132 is the only nonlinear amplifier in nonlinear amplification module 130, apparatus 100 adjusts the power Pₚᵤₘₚ of pump beam 136.

FIG. 4 is a flowchart for one method 400 for chirped pulse amplification with B-integral compensation implemented by apparatus 100. Method 400 includes a CPA process 402. Method 400 also includes a change process 404 that acts on CPA process 402 to increase or decrease the pulse repetition rate and, in accordance therewith, change at least one pump power for the nonlinear amplification so as to achieve the same or similar final ultrashort pulse duration τ₃ at the increased/decreased pulse repetition rate. This final ultrashort pulse duration τ₃ is not necessarily the shortest pulse duration achievable at any given pulse repetition rate, but rather a pulse duration that can be achieved with a desired level of consistency over a range of pulse repetition rates.

CPA process 402 includes steps 410, 420, 430, and 440. In step 410, pulse picker 120 sets the pulse repetition rate of laser pulses 192. In step 420, stretcher 125 temporally stretches laser pulses 192. In step 430, nonlinear amplification module 130 amplifies laser pulses 192. In step 440, compressor 160 imposes chromatic dispersion to compress laser pulses 192. Each of steps 410, 420, 430, and 440 are performed as discussed above in reference to FIG. 1. CPA process 402 may also include additional amplification steps. For example, CPA process 402 may include a step 432 of further amplifying laser pulses 192 in a linear laser amplifier 150 (see FIG. 1) between steps 430 and 440. The gain medium of linear laser amplifier 150 may be a large-mode-area optical fiber or a bulk-optic where the transverse dimensions of laser beam 190 are sufficiently large to keep nonlinear phase shifts at a negligible level. In general, the intensity of laser beam 190 is too low in linear laser amplifier 150 to cause nonlinear phase shifts, even at the peak power of laser pulses 192.

As discussed above in reference to FIG. 1, the order of steps 410 and 420 may be switched, or steps 410 and 420 may be integrated. For example, step 420 may include two or more reflections in one or more fiber Bragg gratings, with the pulse picking of step 410 performed between two of these reflections, or step 420 may include two passes through a pulse picking device with a fiber Bragg grating reflection between the two passes. As also discussed above in reference to FIG. 1, step 430 is performed after step 410, but a portion of step 430 may be integrated with and/or performed before step 420.

Change process 404 includes steps 460 and 470, each of which is effected by controller 170. In step 460, controller 170 regulates pulse picker 120 to change the pulse repetition rate from a first pulse repetition rate f_{rep,1} to a second pulse repetition rate f_{rep,2} that is different from f_{rep,1}. In step 470, controller 170 changes the power of pump beam 136 for nonlinear laser amplifier 132 from a first pump power P_{pump,1} to a second pump power P_{pump,2} that is different from the first pump power P_{pump,1}. That is, controller 170 changes the pump power Pₚᵤₘₚ in step 470 to at least partly compensate for the B-integral change otherwise caused by the change in pulse repetition rate effected in step 460. In a scenario where the second pulse repetition rate f_{rep,2} exceeds the first pulse repetition rate f_{rep,1}, the second pump power P_{pump,2} exceeds the first pump power P_{pump,1}. In a scenario where the second pulse repetition rate f_{rep,2} is less than the first pulse repetition rate f_{rep,1}, the second pump power P_{pump,2} is less than the first pump power P_{pump,1}. Controller 170 may similarly change the pump power for one or more nonlinear laser amplifiers 142 in step 470.

FIG. 5 schematically illustrates the B-integral accumulated by laser pulse 192 at two different pulse repetition rates in method 400, in an example where nonlinear laser amplifier 132 is the only nonlinear amplifier in nonlinear amplification module 130. FIG. 5 plots the absolute B-integral accumulated by laser pulse 192, as a function of propagation distance through the gain medium of nonlinear laser amplifier 132, at pulse repetition rate f_{rep,1} (curve 510) and at a higher pulse repetition rate f_{rep,2} (curve 520). Because the power of pump beam 136 is changed from P_{pump,1} at f_{rep,1} to a higher P_{pump,2} at f_{rep,2}, curves 510 and 520 are identical. The total B-integral accumulated by laser pulse 192 in nonlinear laser amplifier 132 (indicated as point 590) is the same at the two pulse repetition rates. As a result, the final ultrashort pulse duration τ₃ is at least approximately the same at the two pulse repetition rates. The plot of FIG. 5 represents an ideal case. In practical implementations, some deviation between curves 510 and 520 may exist, and the total B-integral accumulated by laser pulse 192 may differ slightly between the two pulse repetition rates.

While the B-integral is helpful for understanding the B-integral compensation technique of method 400, the parameter of practical interest in most applications is the final ultrashort pulse duration τ₃. Therefore, the pump power change(s) in step 470 may be tuned to achieve the same final ultrashort pulse duration τ₃ at the second pulse repetition rate f_{rep,2} as at the first pulse repetition rate f_{rep,1}, at least to within some tolerance. This tuning of step 470 may be performed in a calibration procedure where the final ultrashort pulse duration τ₃ is measured over a range of pulse repetition rates. For example, as shown in FIG. 1, a sensor 180 may measure final ultrashort duration τ₃, or a related parameter, for different pulse repetition rates and vary the pump power of one or more nonlinear laser amplifiers subject to pump-power adjustment in step 470. The result of the calibration procedure is a correspondence between (a) the pulse repetition rate fᵣₑₚ and (b) the pump power Pₚᵤₘₚ for each nonlinear laser amplifier subject to pump-power adjustment in step 470, for at least one final ultrashort duration τ₃. This correspondence may be encoded in controller 170 in the form of a lookup table or a functional relationship.

In one embodiment, sensor 180 measures the actual final ultrashort duration τ₃. In this embodiment sensor 180 may include an autocorrelator. In another embodiment, sensor 180 measures a parameter that is indicative of the final ultrashort duration τ₃. For example, sensor 180 may be a two-photon diode insensitive to the fundamental optical frequency of laser pulses 192 but sensitive to the second-harmonic optical frequency. For a constant pulse energy, the output signal of the two-photon diode increases when the final ultrashort duration τ₃ decreases. If the pulse energy is not constant, measurements from the two-photon diode may be processed together with pulse energy measurements obtained by another sensor to obtain a measure of the final ultrashort duration τ₃.

Instead of relying on calibration, one embodiment of method 400 implements an active feedback loop to control the pump power(s) adjusted in step 470. In this embodiment, method 400 includes a step 450 of monitoring the final ultrashort pulse duration τ₃, or a parameter indicative thereof, using sensor 180. Controller 170 then uses this information to adjust pump power(s) in step 470.

In certain embodiments, the deviation between final ultrashort pulse durations τ₃ achieved at the two pulse repetition rates f_{rep,1} and f_{rep,2} is 15% or less, provided that the two pulse repetition rates f_{rep,1} and f_{rep,2} are within a certain range. In one such embodiment, this pulse-repetition-rate range spans approximately one order of magnitude, e.g., from about 1 MHz to about 10 MHz. In another such embodiment, the upper limit of the pulse-repetition-rate range is at least twice the lower limit of the range. For example, the pulse-repetition-rate range may span from about 1 MHz to about 2 MHz or about 5 MHz. Notably, method 400 is capable of achieving such consistency in the final ultrashort pulse duration τ₃ without changing the configuration of compressor 160. Unlike conventional correction methods, the optical elements of compressor 160 may remain in the same geometrical configuration, relative to each other, when the pulse repetition rate is changed. This capability of method 400 and apparatus 100 applies to even relatively short ultrashort pulse durations τ₃, such as ultrashort pulse durations τ₃ less than 1 ps or less than 200 fs. In one example, laser 110 is based on an ytterbium (Yb³⁺) gain medium, and generates laser pulses 192 with an initial ultrashort pulse duration τ₀ that is in the range between 200 fs and 15 ps.

Method 400 may present an improvement over conventional compressor adjustments, not only in terms of convenience and cost but also in terms of performance. Pump power adjustments are easier to make than compressor adjustments and can be modified over time with relative ease. At least for these reasons, method 400 may achieve more consistent final ultrashort pulse durations τ₃ than conventional compressor adjustment schemes, and/or method 400 may achieve a desired consistency in the final ultrashort pulse duration τ₃ over a wider range of pulse repetition rates. Furthermore, conventional compressor adjustments can only correct linear and quadratic dispersion terms. In contrast, the correction effect of the pump-power adjustments of method 400 is not restricted to certain terms of the dispersion. Rather, the correction effect of method 400 has the capability of maintaining the same dispersion, including higher-order terms, over a range of pulse repetition rates. This property of method 400 also helps improve the consistency in the final ultrashort pulse duration τ₃ and/or extend the range of pulse repetition rates over which a desired consistency is achievable.

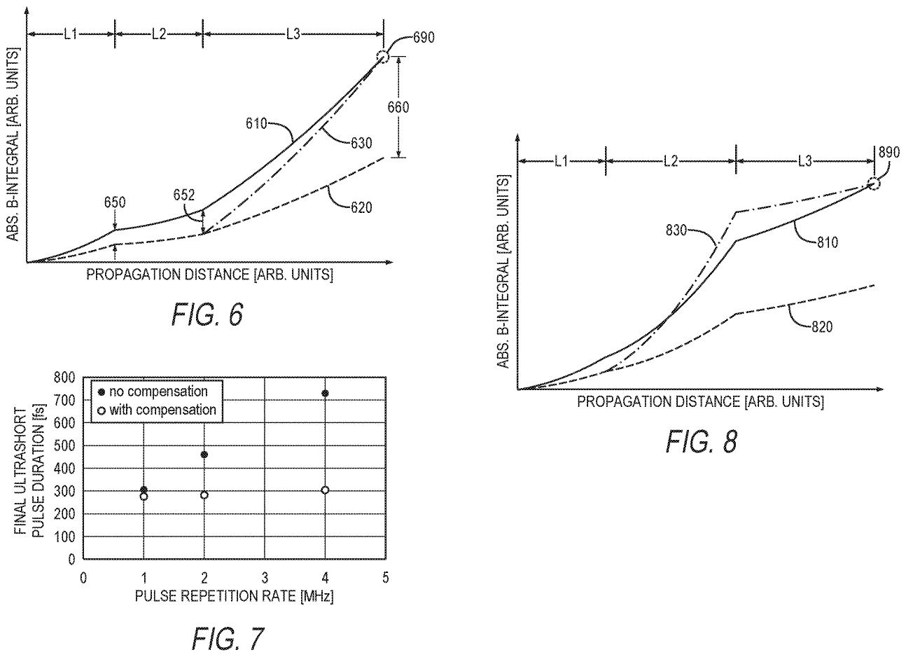

Consider now embodiments of apparatus 100 with two or more nonlinear laser amplifiers in nonlinear amplification module 130, that is, at least one additional nonlinear laser amplifier 142. Even though each of these nonlinear laser amplifiers contributes to the sensitivity of the total B-integral to the pulse repetition rate, it is in many cases sufficient to implement B-integral compensation in only one nonlinear laser amplifier. Method 400 may keep the pump power unchanged for each nonlinear laser amplifier 142 and instead apply a B-integral compensation to nonlinear laser amplifier 132 that is sufficient to compensate for the effect of pulse-repetition-rate change on B-integral accumulation not only in nonlinear laser amplifier 132 but also in each nonlinear laser amplifier 142, for example as discussed below in reference to FIGS. 6-8. Such schemes may be referred to as “single-amplifier-overcompensation” schemes because the pump-power adjustment made to the single nonlinear laser amplifier subject to pump-power adjustment exceeds the adjustment needed to equalize the B-integral accumulation in this single, adjusted nonlinear laser amplifier.

FIG. 6 illustrates one example of a single-amplifier-overcompensation scheme, wherein the pump power for a single nonlinear laser amplifier is adjusted, when the pulse repetition rate is modified, to also compensate for changes to the B-integral accumulated in other preceding, uncompensated nonlinear laser amplifiers. In this example, nonlinear laser amplifier 132 is preceded by two nonlinear laser amplifiers 142. The propagation lengths through the two nonlinear laser amplifiers 142 are L1 and L2, and the propagation length through the nonlinear laser amplifier 132 is L3. Curve 610 schematically plots the B-integral accumulation through nonlinear amplification module 130 at a first pulse repetition rate f_{rep,1}. Each of the three nonlinear laser amplifiers contribute to the total B-integral but the largest contribution comes from the last nonlinear laser amplifier, namely nonlinear laser amplifier 132. This scenario is commonly encountered in chains of laser amplifiers due to the increase in pulse energy through the chain.

Curve 620 schematically plots the B-integral accumulation through nonlinear amplification module 130, in the absence of B-integral compensation, at a second pulse repetition rate f_{rep,2} that is approximately double the first pulse repetition rate. Due to the increased pulse repetition rate, curve 620 exhibits a slower growth resulting in a total difference 660 between the total B-integrals accumulated at the two different pulse repetition rates. Nonlinear laser amplifier 132 and each of nonlinear laser amplifiers 142 contribute to this difference. A difference 650 is evident at the end of the first nonlinear laser amplifier 142, and a slightly larger difference 652 is evident at the end of the second nonlinear laser amplifier 142.

As indicated by curve 630 pertaining to the second pulse repetition rate f_{rep,2}, method 400 overcompensates in nonlinear laser amplifier 132 to correct not only for the contribution from nonlinear laser amplifier 132 to the total difference 660 but also for the contributions from the preceding nonlinear laser amplifiers 142 to the total difference 660. The pump powers are unchanged for nonlinear laser amplifiers 142. Meanwhile, the pump power for nonlinear laser amplifier 132 is increased such that (a) nonlinear laser amplifier 132 imposes a greater B-integral at the higher pulse repetition rate f_{rep,2} than at the lower pulse repetition rate f_{rep,1}, and (b) the total B-integral (point 690) accumulated by laser pulse 192 is the same at the higher pulse repetition rate f_{rep,2} as at the lower pulse repetition rate f_{rep,1}.

FIG. 7 is a data plot showing exemplary final ultrashort pulse durations τ₃ obtained by one embodiment of apparatus 100 at three different pulse repetition rates with B-integral compensation according to method 400 (open circles) and, for comparison, without B-integral compensation (solid circles). In this embodiment of apparatus 100, nonlinear laser amplifier 132 is preceded by two nonlinear laser amplifiers 142. The configuration of compressor 160 is fixed. This fixed compressor configuration is optimized for a pulse repetition rate of 1 MHz and a particular set of pump powers for nonlinear laser amplifier 132 and the two preceding nonlinear laser amplifiers 142.

Without B-integral compensation, the same set of pump powers is used at all three pulse repetition rates. As the pulse repetition rate is increased from 1 MHz, the final ultrashort pulse duration τ₃ increases dramatically (see solid circles in FIG. 7). An increase of the pulse repetition rate from 1 MHz to 4 MHz causes the final ultrashort pulse duration τ₃ to more than double.

B-integral compensation according to method 400 eliminates this problem (see open circles in FIG. 7). In the FIG. 7 example, the pump powers of the two nonlinear laser amplifiers 142 are kept constant, while the pump power for nonlinear laser amplifier 132 is adjusted according to the single-amplifier-overcompensation scheme illustrated in FIG. 6. The resulting final ultrashort pulse durations τ₃ are the same, to within about 10%, at all three pulse repetition rates.

The FIG. 7 data demonstrates the strength of the B-integral compensation technique of method 400 and, in particular, the single-amplifier-overcompensation scheme of FIG. 6. When feasible, the single-amplifier-overcompensation scheme is advantageous due to its simplicity, as compared to adjusting more than a single pump power. The single-amplifier-overcompensation scheme has additional benefits. The fact that the pump power for a single nonlinear laser amplifier can be adjusted to correct a B-integral difference (e.g., difference 660) accumulated through several nonlinear laser amplifiers means that the single-amplifier-overcompensation scheme can correct for B-integral differences accumulated in other overlooked sources of nonlinear phase shifts. Possible sources of overlooked nonlinear phase shifts include laser amplifier 150, presumed to be linear, as well as optical components in stretcher 125. Calibration of the pump power needed for nonlinear laser amplifier 132 at different pulse repetition rates will automatically account for additional sources of nonlinear phase shifts, as will active feedback to tune the pump power for nonlinear laser amplifier 132 (see step 450 in FIG. 4).

While the single-amplifier-overcompensation scheme of FIG. 6 adjusts the pump power for the last nonlinear laser amplifier of nonlinear amplification module 130, single-amplifier-overcompensation is not limited to this scenario. Any nonlinear laser amplifier with sufficient dynamic range, in terms of pump power and resulting B-integral contributions, can be used to also compensate for changes in B-integral contributions from other nonlinear laser amplifiers.

FIG. 8 illustrates an example of another single-amplifier-overcompensation scheme, wherein the adjusted nonlinear laser amplifier is not the last nonlinear laser amplifier of the chain. In this example, nonlinear laser amplifier 132 is sandwiched between two nonlinear laser amplifiers 142. Here, the propagation lengths through the two nonlinear laser amplifiers 142 are L1 and L3, respectively, and the propagation length through the nonlinear laser amplifier 132 is L2. As in the FIG. 6 example, nonlinear laser amplifier 132 provides the largest contribution to the total B-integral. Curves 810, 820, and 830 schematically plot the B-integral accumulation through nonlinear amplification module 130 under different circumstances.

Curve 810 pertains to a first pulse repetition rate f_{rep,1}, and curves 820 and 830 pertain to a second pulse repetition rate f_{rep,2} that is higher than the first pulse repetition rate f_{rep,1}. Curve 820 shows how the B-integral would change if the pump powers are kept constant when the pulse repetition rate is changed from f_{rep,1} to f_{rep,2}. In the case of curve 830, B-integral compensation is implemented in the form of overcompensated pump-power adjustment in nonlinear laser amplifier 132 (the middle nonlinear laser amplifier), such that the total B-integral (point 890) is the same at the second pulse repetition rate f_{rep,2} as at the first pulse repetition rate f_{rep,1}.

The single-amplifier-overcompensation schemes of FIGS. 6 and 8 both adjust the pump power for the nonlinear laser amplifier with the largest contribution to the total B-integral. Depending on the dynamic range, in terms of pump power and resulting B-integral contributions, of the different nonlinear laser amplifiers of nonlinear amplification module 130, it may be possible to instead adjust the pump power for a nonlinear laser amplifier that does not provide the largest contribution to the total B-integral.

The single-amplifier-overcompensation schemes of FIGS. 6 and 8 are readily generalized to adjustment of the pump power for more than one nonlinear laser amplifier in step 470. For example, when nonlinear amplification module 130 includes three nonlinear laser amplifiers, method 400 may adjust the pump power for two of these nonlinear laser amplifiers while leaving the pump power for one remaining laser amplifier unchanged. While one of these pump-power adjustments must be an overcompensation, the other may be an exact compensation or a partial compensation.

B-integral compensation schemes that utilize overcompensation in one or more nonlinear laser amplifiers to compensate also for B-integral accumulation changes in one or more uncompensated nonlinear laser amplifiers, such as those discussed above in reference to FIGS. 6-8, may affect the pulse energy of laser pulse 192 after amplification. As an example, consider the scenario of FIG. 6. When the pulse repetition rate is increased from f_{rep,1} to f_{rep,2}, the pump power for nonlinear laser amplifier 132 is increased to a level that ensures that the B-integral contribution from nonlinear laser amplifier 132 is greater at f_{rep,2} than at f_{rep,1}. This usually corresponds to the per-pulse-gain of nonlinear laser amplifier 132 being greater at f_{rep,2} than at f_{rep,1}. The increased per-pulse-gain of nonlinear laser amplifier 132 is generally not exactly countered by decreased per-pulse-gain in the uncorrected nonlinear laser amplifiers 142. Therefore, the pulse energy of laser pulses 192 after nonlinear amplification module 130 may not be the same at f_{rep,1} and f_{rep,2}. In the case of the FIG. 7 data, the pulse energy was found to increase with pulse repetition rate.

In some applications, it is not important to maintain the same pulse energy at all pulse repetition rates. Other applications, however, require at least nearly identical pulse energies across the range of pulse repetition rates. Referring again to FIG. 4, method 400 may therefore include a step 436 of correcting the pulse energy to achieve the same or similar pulse energies across a desired range of pulse repetition rates. Step 436 may keep any pulse energy variation to within, e.g., 15%. In one example of step 436, the gain of linear laser amplifier 150 is adjusted to achieve the same or similar pulse energies across a desired range of pulse repetition rates. Controller 170 may be communicatively coupled to a pump laser for linear laser amplifier 150 and adjust the gain of linear laser amplifier 150 in accordance with the pulse repetition rate. In another example of step 436, a variable optical loss may be introduced after nonlinear amplification module 130, such as the loss provided by an optical modulator.

The compensation schemes of FIGS. 6-8 assume that each nonlinear laser amplifier of nonlinear laser amplification module 130 imposes a B-integral of the same sign. However, nonlinear laser amplification module 130 may include nonlinear laser amplifiers of different types such that their respective B-integral contributions have opposite signs. The compensation schemes discussed above are readily modifiable to apply to such situations. Also in these situations, the pump power may be adjusted for one or more of the nonlinear laser amplifiers.

The B-integral compensation scheme of method 400 is not limited to chirped pulse amplification. The B-integral compensation scheme may be useful to achieve consistent ultrashort pulse durations, across a range of pulse repetition rates, also in other types of ultrashort laser pulse amplification that involve one or more nonlinear laser amplifiers. In one such example, a beam of ultrashort laser pulses is subjected first to (a) amplification in one or more nonlinear laser amplifiers where self-phase modulation induces anomalous dispersion that spectrally broadens the laser pulses, and then to (b) further amplification in a final laser amplifier where the laser pulses are temporally compressed by gain narrowing. The B-integral compensation scheme of method 400 (steps 460 and 470) may be utilized to achieve the same level of spectral broadening in the one or more nonlinear laser amplifiers when the pulse repetition rate is modified prior thereto. Specifically, this entails changing one or more pump powers for the one or more nonlinear laser amplifiers. The B-integral compensation scheme can, in this example, ensure that the pulse duration after the final laser amplifier is the same (at least to within a desired tolerance) across a range of pulse repetition rates. In one scenario, the final ultrashort pulse duration is between 1 and 50 ps.

Additionally, the B-integral compensation technique of method 400 may be used to maintain a certain final spectral characteristic of compressed pulses 192 in apparatus 100, instead of a certain final pulse duration, across a range of pulse repetition rates. The spectral characteristic stabilized in this manner may be the spectral distribution or spectral bandwidth of compressed pulses 192, or the energy of a particular spectral component of compressed pulses 192. Such a modification of method 400 essentially amounts to switching the figure of merit from the final ultrashort duration to the chosen spectral characteristic. For this purpose, apparatus 100 may include a sensor 180 that measures the chosen spectral characteristic, or a related parameter. For example, sensor 180 may be configured to obtain (a) a full or partial spectral distribution of compressed pulses 192, (b) a spectral bandwidth of compressed pulses 192, or (c) the energy of a particular spectral component of compressed pulses 192. Thus, more generally, the B-integral compensation technique of method 400 may be used to maintain a certain final spectrotemporal characteristic of compressed pulses 192 in apparatus 100, at least to within a certain tolerance. The spectrotemporal characteristic may be (a) a temporal characteristic, for example a final pulse duration as discussed above, (b) a spectral characteristic, for example as discussed above, or (c) a characteristic that is both spectral and temporal.

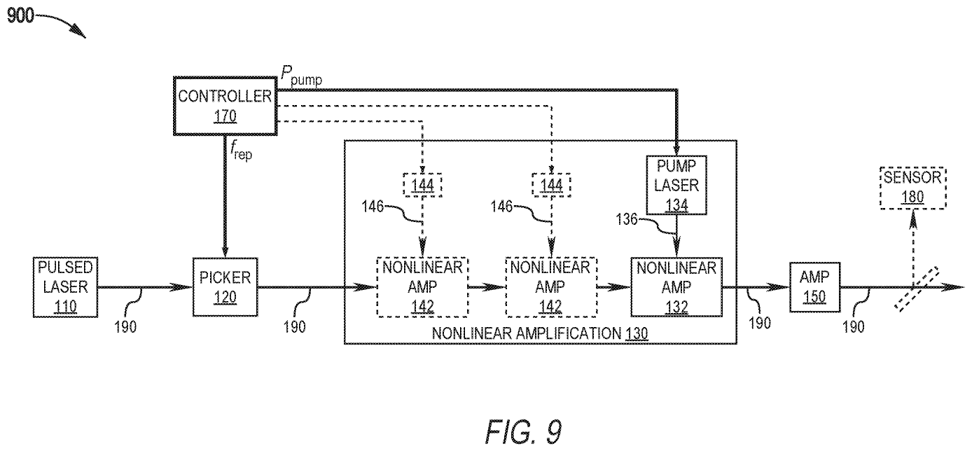

The B-integral compensation concept described herein is not limited to CPA systems but is generally applicable to MOPA systems that generate ultrashort laser pulses with a variable pulse repetition rate. Non-CPA examples are discussed below in reference to FIGS. 9-11.

FIG. 9 illustrates one ultrashort-pulse MOPA laser apparatus 900 with a variable pulse repetition rate. Apparatus 900 implements B-integral compensation in the nonlinear amplification process to achieve consistent laser pulse durations over a range of pulse repetition rates. Apparatus 900 is a modification of apparatus 100 that omits stretcher 125 and compressor 160, and instead applies amplification directly to ultrashort laser pulses.

Apparatus 900 includes pulsed laser 110, pulse picker 120, nonlinear amplification module 130, linear laser amplifier 150, and controller 170. In apparatus 900, the initial ultrashort pulse duration of ultrashort pulses 192 (not depicted in FIG. 9), generated by laser 110, is for example in the picosecond range. Pulse picker 120 sets the pulse repetition rate of laser beam 190 forwarded to nonlinear amplification module 130. Nonlinear amplification module 130 amplifies laser pulses 192, whereafter laser pulses 192 are further amplified by linear amplifier 150.

Nonlinear amplification module 130 may serve not only to amplify laser pulses 192 but also to manipulate the spectrum of laser pulses 192 before amplification by linear amplifier 150. The manipulated spectrum is selected to achieve a desired final ultrashort pulse duration after linear amplifier 150. The final ultrashort pulse duration is typically sensitive to the total B-integral imposed by nonlinear amplification module 130.

In one embodiment, nonlinear amplification module 130 imposes self-phase modulation to spectrally broaden laser pulses 192 to a spectral width required to achieve the desired final ultrashort pulse duration after linear amplifier 150. Gain narrowing in linear amplifier 150 may prevent achieving the desired final ultrashort pulse duration unless laser pulses 192 are spectrally broadened in this manner. In another embodiment, self-phase modulation imposed by nonlinear amplification module 130 generates a transform-limited spectral lobe that can be amplified by linear amplifier 150 while preserving its transform-limited nature. In each of these two embodiments, the final ultrashort pulse duration is sensitive to the self-phase modulation, and thus the B-integral, imposed by nonlinear amplification module 130.

As in apparatus 100, controller 170 controls (a) the pulse repetition rate of laser beam 190 forwarded to nonlinear amplification module 130 and (b) in accordance with the pulse repetition rate, the power of at least one pump beam in nonlinear amplification module 130. The pump power control effected by controller 170 ensures that the total B-integral imposed by nonlinear amplification module 130 is the same at each pulse repetition rate within a certain pulse-repetition-rate range, at least to within some tolerance as discussed above for apparatus 100. This application of B-integral compensation in apparatus 900 is equivalent to a modification of method 400 that omits steps 420 and 440. Any one of the B-integral compensation schemes discussed above in reference to FIGS. 6-8 may be applied to apparatus 900 to maintain the same total B-integral over a range of pulse repetition rates. Furthermore, as in apparatus 100, these B-integral compensation schemes may be used to achieve a consistent spectral characteristic over a pulse-repetition-rate range. Apparatus 900 may include and utilize sensor 180 as discussed above for apparatus 100.

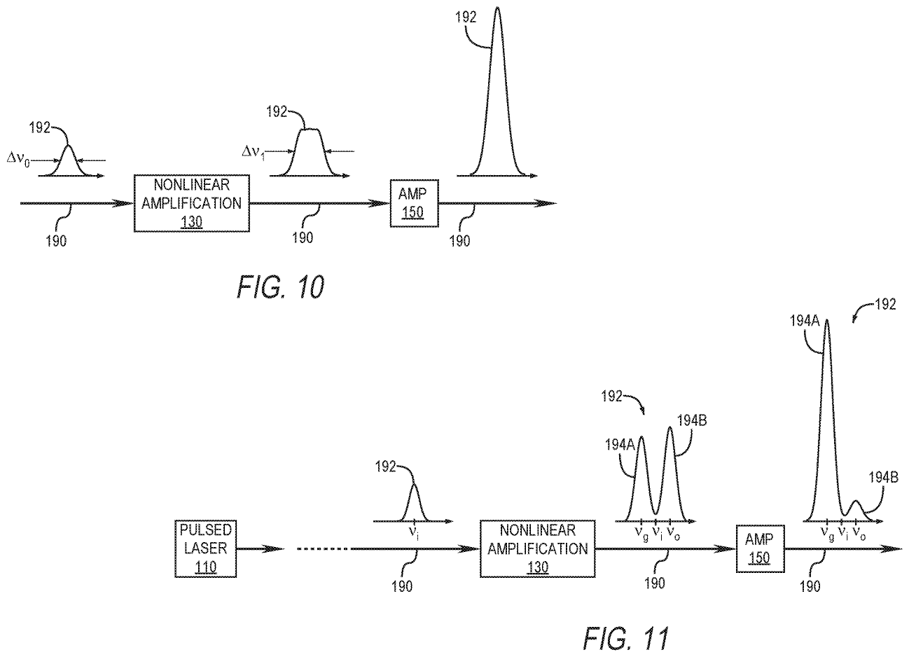

FIG. 10 illustrates the spectral laser pulse evolution in one embodiment of apparatus 900, wherein self-phase modulation in nonlinear amplification module 130 serves to spectrally broaden the laser pulses before linear amplifier 150. Before nonlinear amplification module 130, laser pulse 192 has a spectral width Avo. Self-phase modulation in nonlinear amplification module 130 spectrally broadens laser pulse 192 to a greater spectral width Δv₁. This spectral broadening helps provide the spectral bandwidth required to ensure that laser pulse 192 after amplification in linear amplifier 150 has a desired ultrashort pulse duration.

FIG. 11 illustrates the spectral laser pulse evolution in another embodiment of apparatus 900, wherein self-phase modulation in nonlinear amplification module 130 serves to generate a new spectral lobe that is transform limited (or at least nearly transform limited). In this embodiment of apparatus 900, laser 110 generates laser pulses 192 with an initial spectral lobe centered at an initial optical frequency vᵢ that is offset from the maximum gain frequency v_{g} of nonlinear amplification module 130 and linear amplifier 150. The initial optical frequency vᵢ may even be outside the gain bandwidth of nonlinear amplification module 130.

Nonlinear amplification module 130 imposes self-phase modulation as well as amplification at optical frequencies near the maximum gain frequency v_{g}. The self-phase modulation is necessary to generate a substantial amount of light within the gain bandwidth of nonlinear amplification module 130. Self-phase modulation splits the initial spectral lobe into two separate, transform-limited spectral lobes shifted in opposite directions from the initial optical frequency vᵢ. With the right amount of self-phase modulation, one of these spectral lobes is at the maximum gain frequency v_{g}. Thus, with the right amount of self-phase modulation, nonlinear amplification module 130 generates a new, transform-limited spectral lobe 194A at the maximum gain frequency v_{g} in addition to a new, transform-limited spectral lobe 194B at another optical frequency vₒ that is further offset from the maximum gain frequency v_{g} than the initial optical frequency vᵢ. Subsequent amplification of laser pulse 192 in linear amplifier 150 preferentially amplifies spectral lobe 194A. Spectral lobe 194B is essentially negligible after linear amplifier 150. Linear amplifier 150 maintains the transform-limited nature of spectral lobe 194A, whereby laser pulse 192 (essentially consisting of spectral lobe 194A) has the shortest possible pulse duration.

Additional spectral lobes may exist between spectral lobes 194A and 194B. However, spectral lobe 194A is transform limited only when it is an outermost one of the spectral lobes generated by self-phase modulation. Furthermore, amplification is efficient only when new spectral lobe 194A is well-matched to the maximum gain frequency v_{g}. Matching an outermost spectral lobe to the maximum gain frequency v_{g} requires proper tuning of the self-phase modulation. With insufficient self-phase modulation, not enough light will be available to seed amplification due to the offset between the initial optical frequency vᵢ and the maximum gain frequency v_{g}. Too much self-phase modulation may cause the outermost spectral lobe to shift beyond the maximum gain frequency v_{g}.

B-integral compensation, effected by controller 170 as discussed above, ensures that spectral lobe 194A is transform limited and matched to the maximum gain frequency v_{g} over a range of pulse repetition rates. In one scenario, when the pulse repetition rate is changed from one value to another, controller 170 adjusts one or more pump powers of nonlinear amplification module 130 to ensure that the center optical frequency of spectral lobe 194A is the same at both pulse repetition rates, at least to within some tolerance, e.g., 30 percent of the effective gain bandwidth of linear amplifier 150. Sensor 180 may be implemented to monitor laser pulses 192 between nonlinear amplification module 130 and linear amplifier 150. In another scenario, controller 170 adjusts one or more pump powers of nonlinear amplification module 130 to ensure that the pulse duration or a spectral characteristic of laser pulses 192, after linear amplifier 150, is the same at both pulse repetition rates.

Without departing from the scope hereof, some deviation from laser pulse 192 being exactly transform limited and some error in matching to the maximum gain frequency may exist without causing unacceptable performance degradation.

The above discussion of FIG. 11 assumes that nonlinear amplification module 130 and linear amplifier 150 have identical maximum gain frequencies. While this configuration may provide the most efficient amplification, the maximum gain frequency of linear amplifier 150 may be different from that of nonlinear amplification module 130, as long as the maximum gain frequency of linear amplifier 150 is contained by spectral lobe 194A and reasonably close to its spectral peak.

In a modification of apparatuses 100 and 900, nonlinear laser amplifier 132 and/or one or more nonlinear laser amplifiers 134 of nonlinear amplification module 130 are pumped by a non-laser-based pump source such as a lamp or an electrical current. In relation to this modification of apparatus 100, method 400 is readily modifiable to adjust the pump power of other types of pump sources than pump lasers in step 470.

The present invention is described above in terms of a preferred embodiment and other embodiments. The invention is not limited, however, to the embodiments described and depicted herein. Rather, the invention is limited only by the claims appended hereto.

What is claimed is:

1. A method for chirped pulse amplification, comprising steps of:
stretching laser pulses from an initial ultrashort duration to a longer duration;
setting a pulse repetition rate of the laser pulses delivered to one or more nonlinear laser amplifiers;
amplifying the laser pulses in the one or more nonlinear laser amplifiers, an absolute value of a B-integral imposed on the laser pulses by each nonlinear laser amplifier being an increasing function of a respective pump power and a decreasing function of the pulse repetition rate;
after the stretching and amplifying steps, compressing the laser pulses to a final ultrashort duration by imposing a chromatic dispersion on the laser pulses, a final spectrotemporal characteristic of the laser pulses after said compressing being sensitive to a total B-integral imposed by the one or more nonlinear laser amplifiers; and
changing the pulse repetition rate from a first pulse repetition rate to a second pulse repetition rate; and
for at least one of the one or more nonlinear laser amplifiers, adjusting the respective pump power from a first pump power at the first pulse repetition rate to a second pump power at the second pulse repetition rate, wherein the first and second pump powers, for each nonlinear laser amplifier subject to said adjusting, are selected to maintain the final spectrotemporal characteristic at the first and second pulse repetition rates while the chromatic dispersion imposed in the compressing step is the same at the first and second pulse repetition rates;
wherein (a) the second pulse repetition rate and second pump power exceed the first pulse repetition rate and first pump power, respectively, or (b) the first pulse repetition rate and first pump power exceed the second pulse repetition rate and second pump power, respectively.

2. The method of claim 1, wherein the final spectrotemporal characteristic is the final ultrashort pulse duration, and wherein the first and second pump powers, for each nonlinear laser amplifier subject to said adjusting, are selected such that the final ultrashort duration is the same at the first and second pulse repetition rates to within 15 percent.

3. The method of claim 1, wherein the final spectrotemporal characteristic is a spectral distribution, a spectral bandwidth, or an energy of a selected spectral component.

4. The method of claim 1, wherein the one or more nonlinear laser amplifiers is a chain of nonlinear laser amplifiers, and the adjusting step adjusts the power of the pump beam for a last nonlinear laser amplifier of the chain.

5. The method of claim 4, wherein, for each nonlinear laser amplifier preceding the last nonlinear laser amplifier, the respective pump power is the same at the first and second pulse repetition rates.

6. The method of claim 5, further comprising, after the amplifying step, a step of correcting the pulse energy at least at the second pulse repetition rate so as to achieve the same pulse energy at the first and second pulse repetition rates to within 15 percent.

7. The method of claim 6, wherein the correcting step is performed before the compressing step by an additional laser amplifier or an acousto-optic modulator.

8. The method of claim 4, wherein the last nonlinear laser amplifier has first and second gains, per laser pulse, at the first and second pulse repetition rates, respectively, the second gain being different from the first gain.

9. The method of claim 1, wherein the one or more nonlinear laser amplifiers is a chain of nonlinear laser amplifiers, and the adjusting step adjusts the power of the pump beam for a non-last nonlinear laser amplifier of the chain while keeping the power of the pump beam for every other nonlinear laser amplifier of the chain constant.

10. The method of claim 1, wherein the adjusting step is performed according to a calibration between (a) the pulse repetition rate and (b) the pump power for each nonlinear laser amplifier subject to the adjusting step.

11. The method of claim 1, further comprising a step of monitoring the final spectrotemporal characteristic to provide active feedback to the adjusting step.

12. The method of claim 1, wherein at least one of the one or more nonlinear laser amplifiers amplifies the laser pulses after the stretching step.

13. The method of claim 1, wherein each nonlinear laser amplifier subject to the adjusting step is a fiber amplifier.

14. The method of claim 1, wherein the compressing step is performed by a compressor including a plurality of optical elements including at least one dispersive optic, the optical elements being arranged in a geometrical configuration relative to each other, the geometrical configuration being the same at the first and second pulse repetition rates.

15. The method of claim 1, wherein a ratio of the second pulse repetition rate to the first pulse repetition rate is at least two.
